(19) United States
(12) Patent Application Publication
(10) Pub. No.: US 2013/0145255 A1
(43) Pub. Date: Jun. 6, 2013

(54) SYSTEMS AND METHODS FOR FILTERING WEB PAGE CONTENTS

(71) Applicants: Li-Wei Zheng, Beijing (CN); Jian-Ming Jin, Haidian Beijing (CN); Suk Hwan Lim, Mountain View, CA (US); Jian Fan, San Jose, CA (US); Hui-Man Hou, Beijing (CN); Shi-Jun Tian, Beijing (CN)

(72) Inventors: Li-Wei Zheng, Beijing (CN); Jian-Ming Jin, Haidian Beijing (CN); Suk Hwan Lim, Mountain View, CA (US); Jian Fan, San Jose, CA (US); Hui-Man Hou, Beijing (CN); Shi-Jun Tian, Beijing (CN)

(21) Appl. No.: 13/817,366

(22) PCT Filed: Aug. 20, 2010
(86) PCT No.: PCT/CN10/76177

§ 371 Date: Feb. 15, 2013

(51) Int. Cl. G06F 17/21

(52) U.S. Cl. CPC G06F 17/211
USPC 715/234

(57) ABSTRACT

A system and method for selectively filtering web page contents are disclosed. In one example embodiment a document object model (DOM) structure and visual information of the web page contents are generated. The document object model (DOM) structure and the visual information are analyzed to determine multiple web page content attributes. One or more filtering parameters are selected from the multiple web page content attributes. The web page is filtered based on the one or more filtering parameters.

### BACKGROUND

Web pages provide an inexpensive and a convenient way to make the information available to its customers. However, as the inclusion of multimedia content, embedded advertising, and online services becoming increasingly more prevalent in modern web pages, the web pages themselves have become substantially more complex. For example, in addition to their main content, many web pages display auxiliary content such as background imagery, advertisements, navigation menus, and/or links to additional content.

Web pages contents may be decomposed and used for various outputs. For example, a number of small-and-medium-business web pages may be decomposed into smaller fragments and re-purposed to create marketing collaterals. In another example, a web page may be decomposed into small blocks such that they can be used for selective web printing. However, not all contents of web pages may be desired. Some of the web page contents degrade performances of web content analysis algorithms such as web page segmentation, web layout analysis and block importance calculation. Therefore, filtering desirable contents to gather just the useful content may benefit many web content analysis algorithms downstream.

### BRIEF DESCRIPTION OF THE DRAWINGS

Various embodiments are described herein with reference to the drawings, wherein:

FIG. 1 illustrates a flow diagram of a method for selectively filtering web page contents, according to one embodiment;

FIG. 2 illustrates another flow diagram of a method for selectively filtering web page contents, according to one embodiment;

FIG. 3 illustrates a flow diagram of a method for selectively filtering web page contents using an overflow iterative filter (OIF), according to one embodiment;

FIG. 4A illustrates a screenshot of an illustrative web browser displaying a web page having multiple parameters, in the context of the present disclosure;

FIG. 4B illustrates a screenshot of an exemplary web page parsed into plurality of nodes before filtering, in the context of the present disclosure;

FIG. 5 illustrates a block diagram of a web page filtering module, according to one embodiment; and

FIG. 6 illustrates a block diagram of a system for selectively filtering web page contents, according to an embodiment.

The drawings described herein are for illustration purposes only and are not intended to limit the scope of the present disclosure in any way.

### DETAILED DESCRIPTION

A system and a method for filtering web page contents for a web page analysis are disclosed. In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the invention, and it is to be understood that other embodiments may be utilized and that changes may be made without departing from the scope of the present disclosure. The following detailed description is, therefore, not to be taken in a limiting sense, and the scope of the present disclosure is defined by the appended claims.

The web page filtering process described herein may automatically filter undesirable web page contents for different web page content layouts. The filtered web page contents may be used for web page analysis. For example, the filtered web page contents may be used for web printing, web page segmentation and automated re-publishing of web page contents.

In the document, the term “web page” refers to a document, such as blogs, emails, news and recipes and so on, that can be retrieved from a server over a network connection and viewed in a web browser application. Also, the term “node”, refers to one of a plurality of coherent areas in a web page that are homogeneous in property in a document object model (DOM) tree. The term “homogeneous” refers to characteristic of having content of the same type or property.

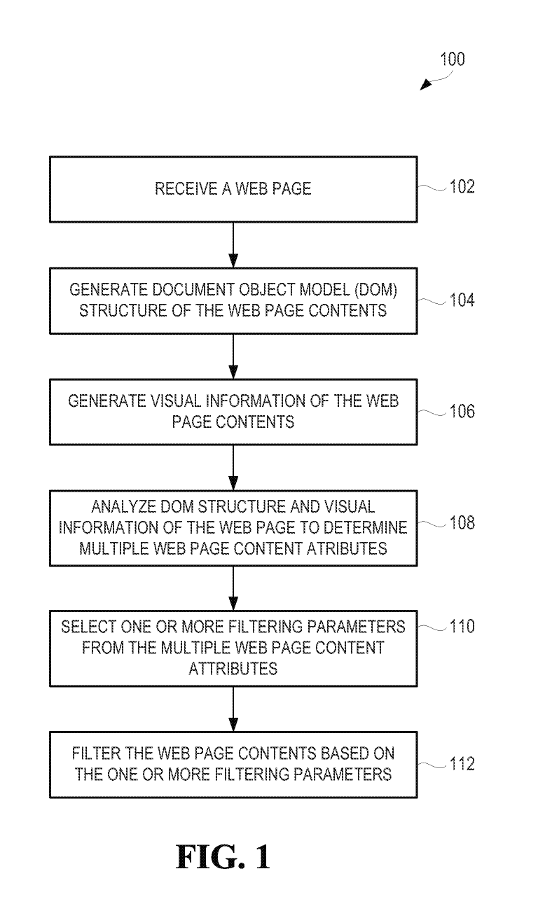

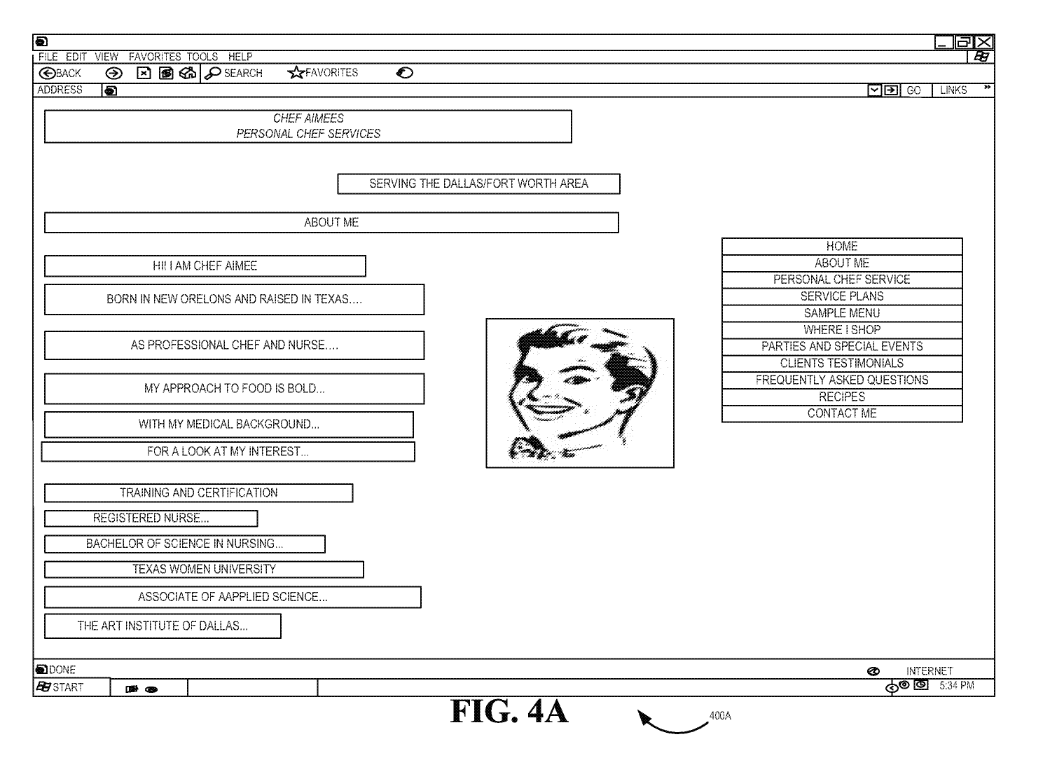

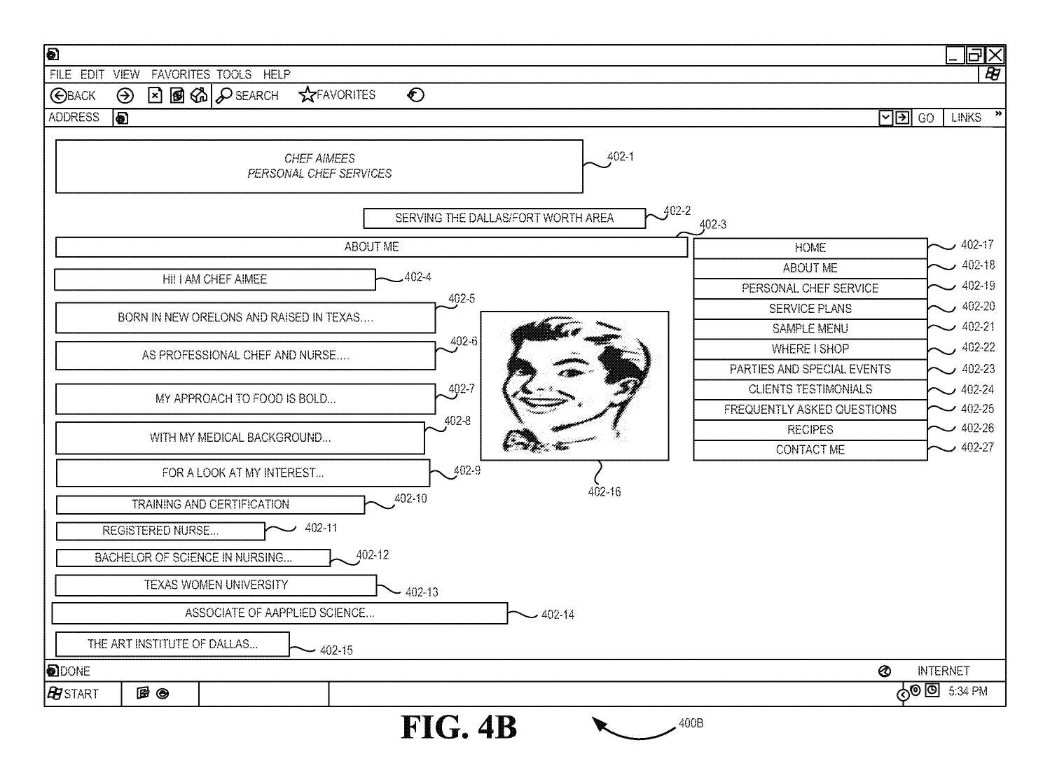

FIG. 1 illustrates a flow diagram of a method for selectively filtering web page contents for web page analysis, according to an embodiment. At block 102, a web page (e.g. the web page shown in FIG. 4A) is received. The web page may be received by a physical computing system. In one example embodiment, a URL for the web page is received by the physical computing system. For example, the physical computing system may perform the functions of fetching the web page from its server and rendering the web page to determine a layout of content in the web page. In another example embodiment, the URL may be specified by a user of the physical computing system or, alternatively, be determined automatically. The physical computing system may then request the Web page from its server over a network such as the internet using the URL.

At block 104, a document object model (DOM) structure of the web page contents is generated. The DOM structure may include a DOM tree having a plurality of nodes. The plurality of nodes of the DOM tree may consists of a plurality of elements in a web page and each node represents an element of the web page contents. The DOM tree may further include a plurality of parent nodes and a plurality of children nodes. The DOM tree may support navigation in any direction that is either through any of the parent nodes or the child nodes. The DOM structure may be generated using a web rendering engine. In one example embodiment, the web rendering engines may be selected from a group consisting of a Webkit, a Gecko, a Trident and a Pesto. The web rendering engines such as Trident and Presto are associated primarily or exclusively with Internet Explorer browser and Opera browser respectively. The web rendering engines such as the Webkit and the Gecko may be shared by number of browsers such as Safari, Google Chrome, Firefox and Flock. The web rendering engines may reside in the physical computing system or on a server in a networked environment.

At block 106, visual information of the web page contents is generated. The visual information may include a bounding box of each of the nodes, coordinates of each of the nodes, coordinates of the bounding boxes of the nodes, a font color of a text in the nodes, a background color of the nodes and other standard attributes. The visual information of the web page content may be generated using web rendering engines. The web rendering engines for generating the visual information may include cascading style sheet (CSS) and dynamic JavaScript.

At block 108, the DOM structure and the visual information of the web page are analyzed to determine multiple web page content attributes. The multiple web page content attributes may include visibility attributes, position attributes, overflow attributes and display attributes for each node of the DOM structure. The multiple web page content attributes may include a z-index attribute of each node of the DOM structure.

At block 110, one or more filtering parameters are selected from the multiple web page content attributes. The one or more filtering parameters may be selected by a user or a system administrator. According to an embodiment, the one or more filtering parameters are configurable and can be predetermined for each web page. According to another embodiment, the one or more filtering parameters are selected from a predetermined list of filtering parameters. The predetermined list of the filtering parameters may include a specified tag filter, a visibility filter, an invalid coordinates filter, a color difference filter, an overflow iterative filter, a text visibility filter, a floating header filter, a floating footer filter, and an advertisement filter.

At block 112, the web page contents are filtered based on the one or more filtering parameters. The filtering of the web page contents based on the one or more filtering parameters may include removing one or more nodes in the DOM tree. According to an embodiment, the one or more nodes in the DOM tree are removed by comparing the visibility attributes and the display attributes of each of the nodes of the DOM tree with a predetermined value of these attributes in the filtering parameters. The filtered web page contents may be used for the web page analysis.

In one embodiment, the web page contents are filtered based on the selected one or more filtering parameters by determining coordinates of a bounding box of each node, determining area of the bounding box of each node, and filtering one or more nodes having an area of the bounding box less than zero. In one example embodiment, the one or more selected nodes having an invalid coordinates of the bounding box are filtered. In another example embodiment, the one or more selected nodes having the bounding box with a height or a width less than zero are filtered.

In another embodiment, the web page contents are filtered by determining a node boundary of each node of the web page, filtering one or more selected nodes having invalid node boundary. In yet another embodiment, the web page contents are filtered by determining a boundary of the web page, determining a node boundary of each node of the web page, comparing the boundary of the web page and the node boundary of the nodes, and filtering the one or more selected nodes whose boundary do not overlap with the boundary of the web page.

In yet another embodiment, the filtering of the one or more nodes in a DOM tree may be accomplished in either parallel or sequential manner. In parallel filtering, the one or more nodes are filtered using the filtering parameters in parallel on the each of the nodes of the DOM tree. In sequential filtering, the one or more nodes are filtered using a first filtering parameter, the filtered nodes are then removed from the DOM tree to create a second DOM tree, the one or more nodes of the second DOM tree are filtered using a second filtering parameter and so on.

In yet another embodiment, the web page contents are filtered by determining a z-index attribute of each of the plurality of nodes of the DOM structure, and filtering the one or more selected nodes by comparing the z-index attribute of each node of the DOM structure with a predetermined value. For example, the z-index includes a bottom attribute, a position attribute and a height attribute. In these embodiments, the one or more nodes having a value of the bottom attribute equal to zero, a value of the position attribute fixed, a value of the z-index attribute bigger than zero, and a value of the height attribute smaller than a predetermined threshold value are filtered.

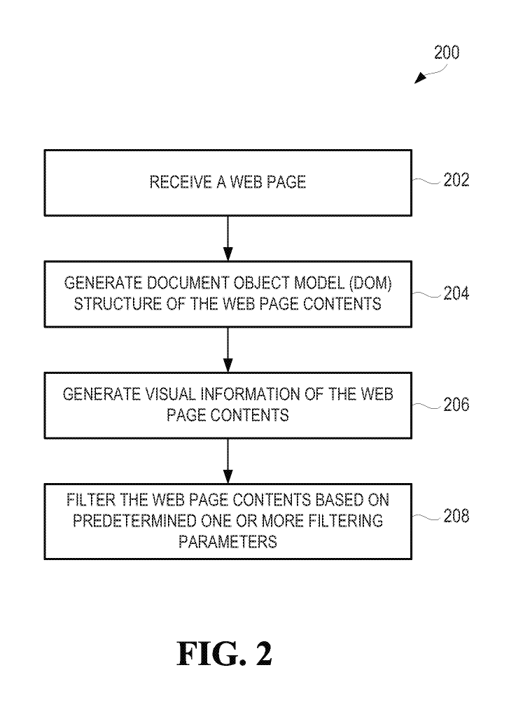

FIG. 2 illustrates another flow diagram of an exemplary method for selectively filtering web page contents. According to an embodiment, this method may be employed to automatically filter the web page contents without any user intervention. At block 202, a web page (e.g. web page shown in FIG. 4A) is received. The web page may be received by a physical computing system. In one example embodiment, a URL for the web page is received by the physical computing system.

At Block 204, a document object model (DOM) structure of the web page is generated. The DOM structure may comprise a DOM tree having a plurality of nodes. The DOM structure may be generated using a web rendering engine.

At block 206, visual information of the web page contents is generated. The visual information may include coordinates of the nodes, a font color of the nodes, a background color and other standard attributes. The visual information of the web page content may be generated using the web rendering engines.

At step 208, the web page contents are filtered based on a predetermined one or more filtering parameters. In accordance with the above described embodiments with respect to FIG. 1 and FIG. 2, the web page contents may be filtered by traversing the DOM tree. The DOM tree may be traversed in either direction, i.e., the DOM tree may be traversed using a top down approach and a bottom up approach. In the top down approach, the DOM tree is traversed from a top node of the DOM tree towards children nodes. In the bottom up approach, the DOM tree is traversed from the children node to the top node. According to an embodiment, the DOM tree may be traversed in a sequential manner or in a parallel manner. In parallel manner, each node of the DOM tree is filtered using all of the one or more parameters. In the sequential manner, each node of the DOM tree is filtered for a first filtering parameter. Remaining nodes of the DOM tree are then filtered using a second filtering parameter and so on.

The predetermined one or more filtering parameters for filtering the web page contents may be determined by a user or a system administrator. According to an embodiment, the one or more filtering parameters may be automatically selected based on the web page contents. According to another embodiment, the one or more filtering parameters may be selected from a group consisting of a specified tag filter, a visibility filter, an invalid coordinates filter, a color difference filter, an overflow iterative filter, a text visibility filter, a floating header filter, a floating footer filter, and an advertisement filter. The one or more filtering parameters are explained in detail as follows.

In one embodiment, the specified tag filter may be used for filtering specified tags in the web page contents. The specified tags may include <style>, <script>, <base>, <meta>, <area>, <noscript> and <option>. The specified tag filter may be configured to filter one or more of the specified tags depending on the web page contents required for the web page analysis. Some specified tags or the content of the specified tags may not be required for the web page analysis. For example, a <object> tag and a <embed> tag are always used for creating a flash and a video. Such dynamic contents such as the flash and the video may not be required for a web printing.

In another embodiment, the visibility filter may be used for filtering one or more nodes based on the visibility attributes and the display attributes of each of the nodes in the DOM tree. In one exemplary implementation, if the visibility of a node equals to false and display is none, the node may be removed from the DOM tree.

In yet another embodiment, the invalid coordinates filter may be used for filtering the one or more nodes based on coordinates of each of the nodes of the DOM tree. The coordinates of each of the nodes of the DOM tree may be generated by the web rending engines. Each of the nodes of the DOM tree may be described by a bounding box (as depicted in FIG. 4A and FIG. 4B). The bounding box for a node may include a value for a top coordinate, a value for a left coordinate, a value for a right coordinate and a value for a bottom coordinate. The generated coordinates for the one or more nodes may be invalid because of special designs or rendering effects. For example, the bounding box of the one or more nodes may be out of the boundary of the web page. As another example, a bounding box for the one or more nodes with a height or a width less than zero are filtered and hence the corresponding nodes may be removed from the DOM tree by the invalid coordinates filter.

In yet another embodiment, the color difference filter may be used for filtering the one or more nodes based on the color properties of each of the nodes of the DOM tree. In one example embodiment, the color difference filter may filter the one or more nodes based on a background color of the node and a text color of the node. Some web page designers may use a font color for hiding watermark text. For example, the watermark text may be hidden using a font color which is similar to the background color. As another example, using a white font color for the watermark text for a white background color. Most of the watermark text may be embedded at the end of a paragraph. Generally, when the user selects part of the main web page content, such unwanted watermark text may also be included in the selection. The color difference filter may filter the nodes having text contents whose font color is same or similar to the background color of the node.

In yet another embodiment, the text validity filter may filter the nodes having text contents which may be used to generate a web page layout format. The text contents used for generating web page layout may or may not be visible to the user. The text visibility filter may filter the invisible text content. Furthermore, the text visibility filter may filter the visible text contents if a text length of the text content is less than a predetermined text length. The predetermined text length may be determined by the user and/or the system administrator.

The floating header filter, floating footer filter and the advertisement filter may filter a floating header, a floating footer and an advertisement respectively from the web page contents. The web page contents may be designed by a z-index attribute and may include multiple layers. The web page contents may further include the floating header, the floating footer and/or the advertisement based on different layers. Such floating elements may change their position according to the user's web browsers boundary. The floating header filter, the floating footer filter and the advertisement filter may filter the one or more nodes from the DOM tree based on the z-index attribute of the nodes. The z-index attribute of each of the nodes in the DOM tree may be generated by the web rendering engines. An user may determine a threshold value for the z-index attribute and nodes may be filtered based on the user determined threshold value. For example, one or more nodes may be filtered from the DOM tree if it meets all of the following conditions:

a value of a bottom attribute is zero,

a value of position attribute is fixed,

the z-index is greater than zero, and

a value of height attribute is smaller than a predetermined threshold value.

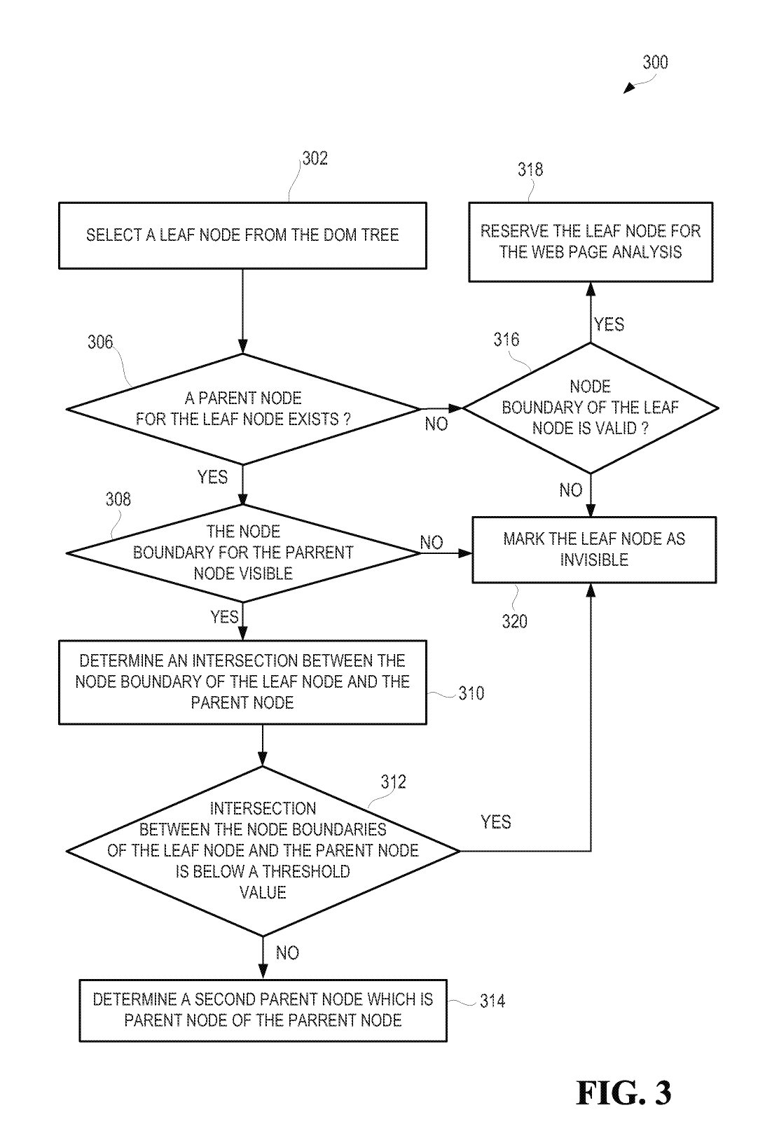

The overflow iterative filter (OIF) may filter the one or more nodes in the DOM tree by comparing the visibility attributes and the display attributes of each node of the DOM tree with a predetermined value. The overflow iterative filter is described with respect to FIG. 3. A computer instruction for the OIF is provided in Appendix A attached to the disclosure.

FIG. 3 illustrates a flow diagram 300 of a method for selectively filtering web page contents using an overflow iterative filter (OIF), according to one embodiment. At block 302, the OIF may select a leaf node of the DOM tree. The leaf node is a node in the DOM tree which does not have a child node. At block 306, the OIF may determine if there is a parent node for the leaf node. If there is a parent node for the leaf node, the OIF may proceed to block 308. If there is no parent node for the leaf node, the OIF ray proceed to block 316.

At block 316, the OIF may determine if the node boundary of the leaf node is valid. The validity of the node boundary may be checked using the coordinates of the bounding box of the leaf node. If the node boundary is valid, the leaf node may be reserved for the web page analysis at block 318. If the node boundary is not valid, the leaf node may be marked as invisible at block 320. According to an embodiment, the leaf node if marked invisible may be removed from the web page analysis. The leaf node marked invisible may also be removed from the DOM tree. According to another embodiment, the leaf node if marked invisible may be filtered from the web page analysis

At block 308, the OIF may determine if the parent node of the leaf node is visible. According to an embodiment a node is visible, if the node is rendered in the browser window over a predetermined minimum size. According to another embodiment the predetermined minimum size for the node to be visible is about 5 pixels.

According to an embodiment a node is visible if both an interior region and a boundary region of the node are visible. In another embodiment, the interior region and the boundary region of the node may be visible to the users. In yet another embodiment, the node may be partially visible. For a partial visible node only part of the node is visible.

According to an embodiment, the visibility of a node may be affected by one or more attributes selected from a list consisting of a display attribute, a visibility attribute, a overflow attribute and a position attribute. According to another embodiment if the display attribute of the node equals to none or the visibility attribute of the node equals to false, the node may not be visible.

According to an embodiment, a non-leaf node in a DOM tree is marked invisible if the size is below a predetermined value, the overflow attribute is equal to hidden and the display attribute equal to inline. The size of the non-leaf node may be determined by multiplying a height and a width of the non-leaf node. According to another embodiment, the non-leaf node may be visible if at least one of the descendant leaf node is visible.

At block 310, if the parent node is visible, then the OIF may determine an intersection between the node boundary of the leaf node and the parent node. The intersection may include an overlap area between the parent node and the lead node. The intersection may be calculated using the coordinates of the parent node and the leaf node.

At block 312, the OIF may determine if the intersection between the node boundary of the selected node and the parent node of the selected node is less than a predetermined value. According to an embodiment, the predetermined value for the intersection is zero. If the intersection is less than the predetermined value, the leaf node may be marked as invisible at block 320. If the intersection is not less than the predetermined value, the OIF will determine a second parent node which is parent node of the parent node of the selected node. The OIF will repeat the process from block 306 to block 320 for the second parent node. The steps from block 306 to block 320 will be repeated for all ancestors (parents of parents) so that the intersection is determined for all ancestors. According to an embodiment the leaf node may be filtered by recursively comparing a leaf node with each of its parent nodes until the intersection between the boundary of the leaf node and the boundary of the parent node is below a predetermined value.

According to an embodiment, the OIF may repeat the steps from block 302 to block 320 for each leaf node in the DOM tree. According to another embodiment, the OIF may repeat the steps from block 302 to block 320 for a predetermined list of the leaf nodes. The predetermined list may be determined by the user or the administrator.

FIG. 4A illustrates a screenshot of an illustrative web browser (400A) displaying a Web page that can be filtered for web page analysis, in the context of the present invention.

FIG. 4B illustrates a screenshot of an exemplary web page (400B) parsed into plurality of nodes before filtering, in the context of the present invention. Particularly, FIG. 4B illustrates a web page parsed into the plurality of nodes (402-1 to 402-27) in consistent with the functionality described with reference to FIG. 1. As shown in FIG. 4B, these nodes (402-1 to 402-27) conform areas in the Web page that are substantially homogenous in property. The nodes (402-1 to 402-27) include text, image, flash, list, input control, and/or visual separator. Further, these nodes (402-1 to 402-27) conform to the requirements of being coherent.

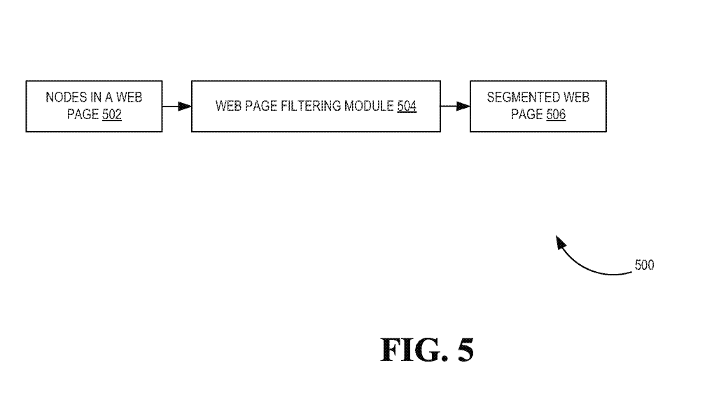

FIG. 5 is a block diagram 500 of a Web page filtering module 504, according to one embodiment. The web page filtering module 504 operable to perform the above mentioned methods. In operation, the filtering module 504 receives a plurality of nodes from a web page 502 and obtains visibility attributes and display attributes for each of the plurality of nodes. In one example embodiment, content in the Web page is parsed into the plurality of nodes 502 using a computer. Further, the web filter module 504 may process the visibility attribute and the display attribute of each node of the web page and filter the one or more nodes based on the user determined filtering parameters. The web filter module 504 may generate a filtered web page 506 for web page analysis.

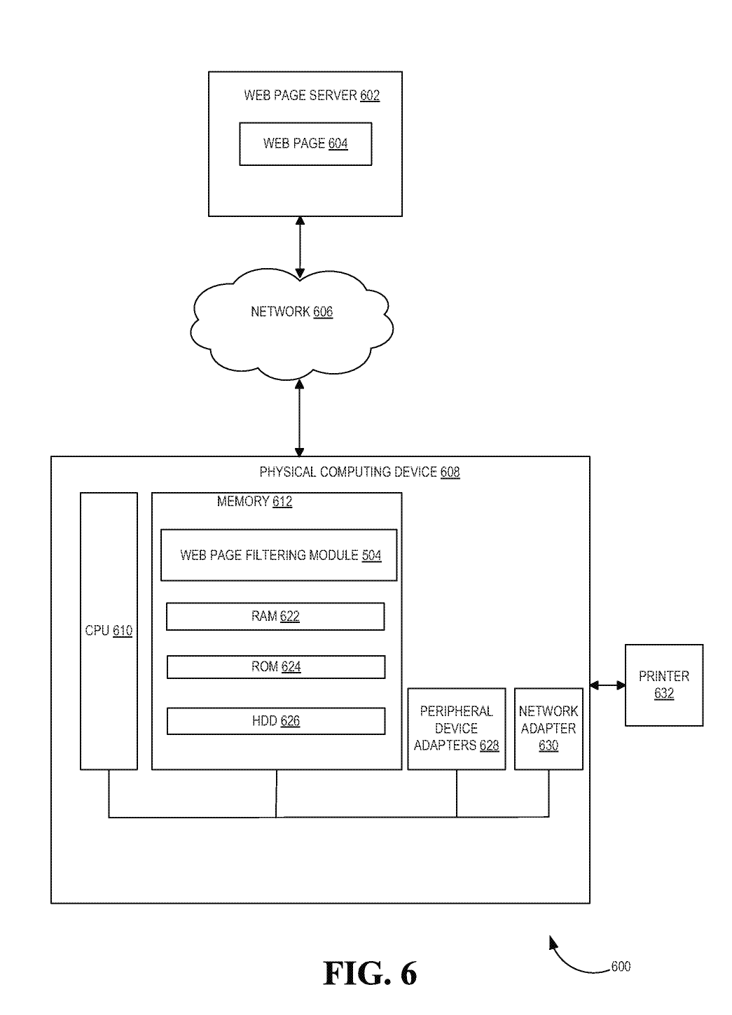

FIG. 6 illustrates a block diagram (600) of a system for filtering a web page using the web page filtering module 504 of FIG. 5, according to one embodiment. Referring now to FIG. 6, an illustrative system (600) for filtering a web page into coherent functional or logical blocks includes a physical computing device (608) that has access to a web page (604) stored by a web page server (602). In the present example, for the purposes of simplicity in illustration, the physical computing device (608) and the web page server (602) are separate computing devices communicatively coupled to each other through a mutual connection to a network (606). However, the principles set forth in the present specification extend equally to any alternative configuration in which the physical computing device (608) has complete access to a web page (604). As such, alternative embodiments within the scope of the principles of the present specification include, but are not limited to, embodiments in which the physical computing device (608) and the web page server (602) are implemented by the same computing device, embodiments in which the functionality of the physical computing device (608) is implemented by a multiple interconnected computers (e.g., a server in a data center and a user's client machine), embodiments in which the physical computing device (608) and the web page server (602) communicate directly through a bus without intermediary network devices, and embodiments in which the physical computing device (608) has a stored local copy of the web page (604) to be filtered.

The physical computing device (608) of the present example is a computing device configured to retrieve the web page (604) hosted by the web page server (602) and divide the web page (604) into multiple coherent, functional blocks. In the present example, this is accomplished by the physical computing device (608) requesting the web pale (604) from the web page server (602) over the network (606) using the appropriate network protocol (e.g., Internet Protocol (“IP”)). Illustrative processes of filtering the web page content will be set forth in more detail below.

To achieve its desired functionality, the physical computing device (608) includes various hardware components. Among these hardware components may be at least one processing unit (610), at least one memory unit (612), peripheral device adapters (628), and a network adapter (630). These hardware components may be interconnected through the use of one or more busses and/or network connections.

The processing unit (610) may include the hardware architecture necessary to retrieve executable code from the memory unit (612) and execute the executable code. The executable code may, when executed by the processing unit (610), cause the processing unit (610) to implement at least the functionality of retrieving the Web page (604) and semantically filtering the Web page (604) into coherent functional or logical blocks according to the methods of the present specification described below. In the course of executing code, the processing unit (610) may receive input from and provide output to one or more of the remaining hardware units.

The memory unit (612) may be configured to digitally store data consumed and produced by the processing unit (610). Further, the memory unit (612) includes the Web page filtering module 504 of FIG. 5. The memory unit (612) may also include various types of memory modules, including volatile and nonvolatile memory. For example, the memory unit (612) of the present example includes Random Access Memory (RAM) 622, Read Only Memory (ROM) 624, and Hard Disk Drive (HDD) memory 626. Many other types of memory are available in the art, and the present specification contemplates the use of any type(s) of memory in the memory unit (612) as may suit a particular application of the principles described herein. In certain examples, different types of memory in the memory unit (612) may be used for different data storage needs. For example, in certain embodiments the processing unit (610) may boot from ROM, maintain nonvolatile storage in the HDD memory, and execute program code stored in RAM.

The hardware adapters (628, 630) in the physical computing device (608) are configured to enable the processing unit (610) to interface with various other hardware elements, external and internal to the physical computing device (608). For example, peripheral device adapters (628) may provide an interface to input/output devices to create a user interface and/or access external sources of memory storage. Peripheral device adapters (628) may also create an interface between the processing unit (610) and a printer (632) or other media output device. For example, in embodiments where the physical computing device (608) is configured to generate a document based on functional blocks extracted from the Web page's content, the physical computing device (608) may be further configured to instruct the printer (632) to create one or more physical copies of the document.

A network adapter (630) may provide an interface to the network (606), thereby enabling the transmission of data to and receipt of data from other devices on the network (606), including the web page server (602).

The above described embodiments with respect to FIG. 6 are intended to provide a brief, general description of the suitable computing environment 600 in which certain embodiments of the inventive concepts contained herein may be implemented.

As shown, the computer program includes the web page filtering module 504 for filtering a web page including a plurality of nodes. For example, the web page filtering module 504 described above may be in the form of instructions stored on a non-transitory computer-readable storage medium. An article includes the non-transitory computer-readable storage medium having the instructions that, when executed by the physical computing device 608, causes the computing device 608 to perform the one or more methods described in FIGS. 1-6.

In various embodiments, the methods and systems described in FIGS. 1 through 6 is easy to implement using the above mentioned method. Furthermore, the above mentioned system is simple to construct and efficient in terms of processing time required for filtering the web page. Further, the above mentioned methods and systems are adaptive to different types of web pages since the filtering parameters are estimated by analyzing the visual attributes and the spatial attributes of the nodes. In addition, the above mentioned methods and systems are adaptive to both the page structure as well as the user's intent, since it can be adjusted by different requirements on filtration granularity.

Further, the methods and systems described in FIGS. 1 through 6, automatically detects the more noisy contents. The methods and systems can be applied to diverse web pages. The methods and systems can include a general and platform-independent approach for web page rendering engines.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

### APPENDIX A

For a leaf node A, the OIF trace up the parent nodes of A to compute the visible region of A to determine if it is visible, as described in the following.

```
boolean isAbsolutePositioned;
if (A.style( ).position.equalsIgnoreCase(“absolute”))
    isAbsolutePositioned = true;
else
    isAbsolutePositioned = false;
Node parent = A.parent( );
while (parent != null) {
    if (parent.style( ).position.equalsIgnoreCase(“absolute”))
        isAbsolutePositioned = true;
    if (!parent.style( ).overflow.equals(“visible”) &&
        parent.style( ).display != Style.Display.inline &&
        ( !isAbsolutePositioned
        || !parent.style( ).position.equalsIgnoreCase(“static”) ) ) {
        // modify the bounding box only for leaf nodes for getting
        the accurate info
            Rectangle overlap =
            A.boundingBox( ).intersection(parent.boundingBox( ));
            A.boundingBox( ).setRect(overlap);
            if ( (A.boundingBox( ).width*A.boundingBox( ).-
            height)<MIN_SIZE )
                return false to indicate “A is INVISIBLE”;
            }
            parent = parent.parent( );
    } // while
Return true to indicate “A is VISIBLE”;
```

What is claimed is:

1. A method of selectively filtering web page contents for web page analysis, comprising:
generating a document object model (DOM) structure and a visual information of the web page contents;
analyzing the DOM structure and the visual information to determine multiple web page content attributes for filtering;
selecting one or more filtering parameters from the multiple web page content attributes; and
filtering the web page contents based on the selected one or more filtering parameters for the web page analysis.

2. The method of claim 1, wherein the one or more filtering parameters are selected from the group consisting of a specified tag filter, a visibility filter, an invalid coordinates filter, a color difference filter, an overflow iterative filter, a text visibility filter, a floating header filter, a floating footer filter, and an advertisement filter.

3. The method of claim 1, wherein the DOM structure includes a plurality of nodes and wherein filtering the web page contents based on the selected one or more filtering parameters comprises:
determining coordinates of a bounding box of each node;
filtering the one or more nodes having an invalid coordinates of the bounding box.

4. The method of claim 3, wherein filtering the one or more nodes comprises:
filtering the one or more nodes having the bounding box with a height or a width less than zero.

5. The method of claim 1, wherein the DOM structure includes a plurality of nodes and wherein filtering the web page contents comprises:
determining a node boundary of each node of a web page; and
filtering one or more nodes having invalid node boundary.

6. The method of claim 1, wherein the DOM structure includes a plurality of nodes and wherein filtering the web page contents comprises:
determining an intersection between the boundary of a leaf node and the node boundary of a parent node of the leaf node, wherein the leaf node is a node having no child node in the DOM structure; and
filtering one or more leaf nodes based on the intersection between the boundary of the leaf node and the boundary of the parent node.

7. The method of claim 6, wherein filtering each leaf node comprises:
filtering each leaf node by recursively comparing with each of its parent nodes until the intersection between the boundary of the leaf node and the boundary of the parent node is below a predetermined value.

8. The method of claim 1, wherein the DOM structure includes a plurality of nodes and wherein filtering the web page contents comprises:
determining a z-index attribute of each of the plurality of nodes of the DOM structure, wherein the z-index attribute comprises a bottom attribute, a position attribute and a height attribute; and
filtering one or more nodes by comparing the z-index attribute of each node of the DOM structure with a predetermined value.

9. The method of claim 8, wherein filtering the one or more nodes by comparing the z-index attribute of each node of the DOM structure with a predetermined value, comprises filtering the nodes having:
a value of the bottom attribute equal to zero;
a value of the position attribute fixed;
a value of the z-index attribute bigger than zero; and
a value of the height attribute smaller than a predetermined threshold value.

10. A system for selectively filtering web page contents for web page extraction, comprising:
a processor; and
a memory operatively coupled to the processor, wherein the memory includes a web page filtering module for filtering the web page contents, having instructions capable of:
generating a document object model (DOM) structure and a visual information of the web page contents;
analyzing the DOM structure and the visual information to determine multiple web page content attributes;
selecting one or more filtering parameters from the multiple web page content attributes; and
filtering the web page contents based on the selected one or more filtering parameters for the web page extraction.

11. The system of claim 10, wherein the DOM structure comprises a plurality of nodes and wherein filtering the web page contents comprises:
determining a boundary box and coordinates of the boundary box for each of the plurality of nodes; and
filtering one or more nodes having an invalid coordinates of the boundary box.

12. The system of claim 11, further comprising filtering the one or more nodes having the boundary box with a height or a width less than zero.

13. The system of claim 10, wherein the one or more filtering parameters are selected from a group consisting of specified tag filter, visibility filter, invalid coordinates filter, color difference filter, overflow iterative filter, text visibility filter, floating header filter, floating footer filter, and advertisement filter.

14. The system of claim 13, wherein the color difference filter comprises filtering text contents having a font color similar to a background color.

15. A non-transitory computer-readable storage medium for selective filtering of web page contents for web page extraction, having instructions that, when executed by a computing device, causes the computing device to perform a method comprising:
generating a document object model (DOM) structure and a visual information of the web page contents;
analyzing the DOM structure and the visual information to determine multiple web page content attributes;
selecting one or more filtering parameters from the multiple web page content attributes; and
filtering the web page contents based on the selected one or more filtering parameters for the web page extraction.
